(19) United States
(12) Patent Application Publication
(10) Pub. No.: US 2010/0010181 A1
(43) Pub. Date: Jan. 14, 2010

(54) Catalyst Activators, Processes For Making Same, And Use Thereof In Catalysts And Polymerization Of Olefins

(75) Inventors: Lubin Luo, Baton Rouge, LA (US); Zhike Wang, Baton Rouge, LA (US); Steven P. Diefenbach, Baton Rouge, LA (US)

Correspondence Address: ALBEMARLE CORPORATION;PATENT DEPARTMENT, 451 FLORIDA STREET, BATON ROUGE, LA, 70801, US

(73) Assignee: ALBEMARLE CORPORATION, BATON ROUGE, LA (US)

(21) Appl. No.: 12/442,334

(22) PCT Filed: Sep. 17, 2007
(86) PCT No.: PCT/US2007/078623

§ 371 Date: Mar. 20, 2009

Related U.S. Application Data
(60) Provisional application No. 60/846,066, filed on Sep. 20, 2006.
(60) Provisional application No. 60/869,971, filed on Dec. 14, 2006.

(51) Int. Cl. C08F 4/52; B01J 31/14; B01J 21/16

(52) U.S. Cl. 526/212; 502/167; 502/62

(57) ABSTRACT

A composition useful for activating catalysts for olefin polymerization is provided. The composition is derived from at least; carrier containing water; organoaluminum compound; N,N-dimethylaniline and pentafluorophenol in amounts such that there are at least two equivalents of pentafluorophenol per equivalent of the N,N-dimethylaniline.

### BACKGROUND

Partially hydrolyzed aluminum alkyl compounds known as aluminoxanes (AO) are used for activating transition metals for olefin polymerization activity. One such compound, methylaluminoxane (MAO), is a frequently chosen aluminum co-catalyst/activator in the industry. Considerable effort has been devoted to improving the effectiveness of catalyst systems based on use of aluminoxanes or modified aluminoxanes for polymerization of olefins. Representative patents and publications in the field of aluminoxane usage include the following: U.S. Pat. No. 5,324,800 to Welborn et al.; U.S. Pat. No. 4,752,597 to Turner; U.S. Pat. Nos. 4,960,878 and 5,041,584 to Crapo et al.; WO 96102580 to Dall'occo, et al.; EP 0 277 003 and EP 0 277 004 to Turner; Hlatky, Turner, and Eckman, J. Am. Chem., Soc., 1989, 111, 2728-2729; Hlatky and Upton, Macromolecules, 1996, 29, 8019-80.20. U.S. Pat. No. 5,153,157 to Hlatky and Turner; U.S. Pat. No. 5,198,401 to Turner, Hlatky, and Eckman; Brintzinger, et al., Angew. Chem. Int. Ed Eng., 1995, 34, 1143-1170; and the like. Despite technological advances, many aluminoxane-based polymerization catalyst activators still lack the activity and/or thermal stability needed for commercial applicability, require commercially unacceptably high aluminum loading, are expensive (especially MAO), and have other impediments to commercial implementation.

Many of the limiting features surrounding the use of aluminoxanes as activators for transition metals, for example, activity limitations—and the need for high aluminum loading, can be addressed by the use of stable or metastable hydroxyaluminoxanes. As compared to aluminoxanes, hydroxyaluminoxanes are generally highly active, provide reduced levels of ash, and result in improved clarity in polymers formed from such catalyst compositions, One representative hydroxyaluminoxane is hydroxyisobutylaluminoxane (HO-IBAO), which can be derived from hydrolysis of triisobutylaluminum (TIBA) at low temperatures. Hydroxyaluminoxane compositions are disclosed in U.S. Pat. Nos. 6,562,991, 6,555,494, 6,492,292, 6:462,212, and 6,160,145.

in contrast to aluminoxanes, which appear to act as Lewis acids to activate transition metals, hydroxyaluminoxane species (generally abbreviated HO-AO) comprise active protons, and appear to activate transition metals by functioning as Bronsted acids. As used herein, an active proton is a proton capable of metal alkyl protonation. A typical hydroxyaluminoxane comprises a hydroxyl group bonded to at least one of its aluminum atoms. To form hydroxyaluminoxanes, typically a sufficient amount of water is reacted with an alkyl aluminum compound under appropriate conditions, for example at low temperature in hydrocarbon solvents, such that a compound having at least one HO—Al group is generated, which is capable of protonating a hydrocarbyl ligand from a d or f-block organometallic compound to form a hydrocarbon. Therefore, polymerization catalysts derived from a hydroxyaluminoxane usually comprise: 1) a cation derived from a transition, lanthanide or actinide metal compound, for example a metallocene, by loss of a leaving group, and 2) an aluminoxate anion derived by transfer of a proton from a stable or metastable hydroxyaluminoxane to the leaving group. The leaving group is usually transformed into a neutral hydrocarbon thus rendering the catalyst-forming reaction irreversible.

One feature of hydroxyaluminoxanes is that their active protons are often thermally unstable when maintained in solution at ambient temperatures, likely due to the loss of active protons through alkane elimination. Thus, hydroxyaluminoxanes are frequently stored at temperatures lower than ambient temperature to maintain the active proton concentration. Storage at low temperatures is typically from about −20° C. to about 0° C. In the absence of handling at such low temperatures, the hydroxyaluminoxane activity decreases rapidly. Storage at such low temperatures is commercially cost prohibitive, especially over extended periods of time.

Thus, a need exists for compositions suitable for activating transition metals for olefin polymerization that have more thermally-robust active protons, as compared to currently available hydroxyaluminoxanes, that exhibit suitably high activity for commercial olefin polymerization. Additionally, a need exists for such compositions that are not derived from aluminoxanes, which tend to be commercially cost-prohibitive.

### THE INVENTION

This invention meets the above-described needs by providing compositions derived from at least: a) carrier containing water; b) organoaluminum compound; c) Lewis base; and d) Bronsted acid, wherein the Lewis base and the Bronsted acid form at least one ionic Bronsted acid, which compositions meet the above-described need. This invention also provides methods of preparing compositions comprising combining least: a) carrier containing water; b) organoaluminum compound; c) Lewis base; and d) Bronsted acid, wherein the Lewis base and the Bronsted acid form at least one ionic Bronsted acid.

This invention also provides compositions derived from at least: a) carrier containing water; b) organoaluminum compound; and c) N,N-dimethylaniline and pentafluorophenol in amounts such that there are at least two equivalents of pentafluorophenol per equivalent of the N,N-dimethylaniline, and methods of preparing compositions comprising combining at least: a) carrier containing water; b) organoaluminum compound and c) N,N-dimethylaniline and pentafluorophenol in amounts such that there are at least two equivalents of pentafluorophenol per equivalent of the N,N-dimethylaniline.

As will be familiar to those skilled in the art, the terms “combined” and “combining” as used herein mean that the components that are “combined” or that one is “combining” are put into a container with each other. Likewise a “combination” of components means the components having been put together in a container. This invention also provides such compositions and methods wherein the composition is an activator composition.

### Carriers/Supports

Carriers containing water useful in compositions according to this invention comprise inorganic carriers or organic carriers. Such carriers contain water and particularly, are those in which an absorbed water has not been perfectly eliminated. Also, such carriers may be those in which a predetermined amount of water has been added, or which are dried so that an absorbed water is incompletely eliminated therefrom. This invention provides that such carriers can contain up to less than 6 wt % water content. Such carriers can be either non-calcined or low-temperature calcined. As used herein, a “non-calcined” carrier is a carrier that has not purposely been subjected to calcining treatment, and a “low-temperature calcined” carrier is carrier that has been calcined at a temperature up to less than 200° C., or up to about 100° C., or at about 50° C. The calcination time can be at about 86° C. for about 4 hours. Further, the calcination may be performed in any atmosphere, for example, in an atmosphere of air or an inert gas, or under a vacuum.

Carriers containing water that are useful in activator compositions according to this invention comprise inorganic carriers or organic carriers. A plurality of carriers can be used as a mixture, and carriers of this invention may comprise water as absorbed water or in hydrate form. A carrier of this invention may be porous and have a total pore volume of not less than 0.1 ml/g of silica, or not less than 0.3 ml/g. A carrier of this invention may have a total pore volume of about 1.6 m/g of silica. The average particle diameter of the carrier may be from about 5 micrometers to about 1000 micrometers, or from about 10 micrometers to about 500 micrometers.

One silica useful in this invention is porous and has a surface area in the range of from about 10 m²/g silica to about 1000 m²/g silica, including the range of about 10 m²/g silica to about 700 m²/g silica, a total pore volume in the range of from about 0.1 cc/g silica to about 4.0 cc/g silica, and an average particle diameter in the range of from about 10 micrometers to about 500 micrometers. A silica useful in this invention can have a surface area in the range of from about 50 m²/g to about 500 m²/g, a pore volume in the range of from about 0.5 cc/g to about 3.5 cc/g, and an average particle diameter in the range of from about 15 micrometers to about 150 micrometers. A useful silica may have a surface area in the range of from about 200 m²/g to about 350 m²/g, a pore volume in the range of from about 1.0 cc/g to about 2.0 cc/g, and an average particle diameter in the range of from about 10 micrometers to about 110 micrometers.

An average pore diameter of a typical porous silicon dioxide carrier useful in this invention is in the range of from about 10 angstroms to about 1000 angstroms, or from about 50 angstroms to about 500 angstroms, or from about 175 angstroms to about 350 angstroms. A typical content of hydroxyl groups is from about 2 mmol OH/g silica to about 10 mmol OH/g silica, with or without the presence of hydrogen-bonded water, as determined by the following Grignard reaction. Most of these active OH groups react readily with benzylmagnesium chloride Grignard to produce toluene, and this reaction can be used to quantify the concentration of active OH groups on a particular silica. Alternatively, triethylaluminum can be used for the titration in place of a Grignard reagent A typical content of hydroxyl groups is from about 2 mmol OH/g silica to about 10 mmol OH/g silica, or about 3 mmol OH/g silica to about 8 mmol OH/g silica, or from about 3.3 mmol OH/g silica to about 7.2 mmol OH/g silica.

Example inorganic carriers that may be useful in this invention include inorganic oxides, magnesium compounds, clay minerals and the like. The inorganic oxides can comprise silica, alumina, silica-alumina, magnesia, titania, zirconia, and clays. Example inorganic oxides useful in this invention include, without limitation, SiO₂, Al₂O₃, MgO, ZrO₂, TiO₂, B₂O₃, CaO, ZnO, BaO, ThO₂ and double oxides thereof, e.g. SiO₂—Al₂O₃, SiO₂—MgO, SiO₂-iO₂, SiO₂—TiO₂—MgO. Example magnesium compounds useful in this invention include MgCl₂, MgCl(OEt) and the like. Example clay minerals useful in this invention include kaolin, bentonite, kibushi clay, geyloam clay, allophane, hisingerite, pyrophylite, talc, micas, montmorilonites, vermiculite, chlorites, palygorskite, kaolinite, nacrite, dickite, halloysite and the like.

Example organic carriers that may be useful in this invention include acrylic polymer, styrene polymer, ethylene polymer, propylene polymer and the like. Example acrylic polymers that may be useful in this invention include polymers of acrylic monomers such as acrylonitrile, methyl acrylate, methyl methacrylate, methacrylonitrile and the like, and copolymers of the monomers and crosslinking polymerizable compounds having at least two unsaturated bonds. Example styrene polymers that may be useful in this invention include polymers of styrene monomers such as styrene, vinyltoluene, ethylvinylbenzene and the like, and copolymers of the monomers and crosslinking polymerizable compounds having at least two unsaturated bonds. Example crosslinking polymerizable compound having at least two unsaturated bonds include divinylbenzene, trivinylbenzene, divinyltoluene, divinylketone, diallyl phthalate, diallyl maleate, N,N′-methylenebisacrylamide, ethylene glycol dimethacrylate, polyethylene glycol dimethacrylate and the like.

Organic carrier useful in this invention has at least one polar functional group. Examples of suitable polar functional groups include primary amino group, secondary amino group, imino group, amide group, imide group, hydrazide group, amidino group, hydroxyl group, hydroperoxy-group, carboxyl group, formyl group, methyloxycarbonyl group, carbamoyl group, sulfa group, sulfino group, sulfeno group, thiol group, thiocarboxyl group, thioformyl group, pyrrolyl group, imidazolyl group, piperidyl group, indazolyl group and carbazolyl group. When the organic carrier originally has at least one polar functional group, the organic carrier can be used as it is. One or more kinds of polar functional groups can also be introduced by subjecting the organic carrier as a matrix to a suitable chemical treatment. The chemical treatment may be any method capable of introducing one or more polar functional groups into the organic carrier. For example, it may be a reaction between acrylic polymer and polyalkylenepolyamine such as ethylenediamine, propanediamine, diethylenetriamine, tetraethylenepentamine, dipropylenetriamine or the like. As the specific method of such a reaction, for example, there is a method of treating an acrylic polymer (e.g. polyacrylonitrile) in a slurry state in a mixed solution of ethylenediamine and water at 100° C. or more, for example from 120° C. to 150° C. The amount of polar functional group per unit gram in the organic carrier having a polar functional group may be from 0.01 to 50 mmol/g, or from 0.1 to 20 mmol/g.

### Organoaluminum Compounds

Organoaluminum compounds useful in this invention can comprise AlRⁿ(XR¹)₍₃₋ₙ₎ wherein Al is aluminum; each R is hydrogen or a hydrocarbyl group having up to about 20 carbon atoms, and each R may be the same as, or different from, any other R; for each XR¹, X is a hetero atom and R¹ is an organic group bonded to the Al through the hetero atom and having up to about 20 carbon atoms; each XR¹ may be the same as, or different from, any other XR¹; and n is 1, 2, or 3. Each R can be a straight-chain or branched alkyl group. Non-limiting examples of R include alkyl groups having from 1 to about 10 carbon atoms such as methyl, ethyl, n-propyl, isopropyl, n-butyl, isobutyl, n-pentyl, neopentyl and the like.

Non-limiting examples of AlRₙ(XR¹)₍₃₋ₙ₎ useful in this invention include triethylaluminum, triisobutylaluminum, trimethylaluminum, trioctylaluminum, diisobutylaluminum hydride, diethylaluminum hydride, dimethylaluminum hydride, (2,6-di-tert-butyl-4-methylphenoxy)diisobutylaluminum, bis(2,6-di-tert-buty-4-methylphenoxy)isobutylaluminum, (2,6-di-tert-butyl-4-methylphenoxy)diethylaluminum, bis(2,65-di-tert-butyl-4-methylphenoxy)ethylaluminum, (2,6-di-tert-butyl-4-methylphenoxy)dimethylaluminum, or bis(2,6-di-tert-butyl-4-methylphenoxy)methylaluminum, and mixtures thereof. Examples of hetero atoms include nitrogen atom, oxygen atom, phosphorous atom, sulfur atom and the like.

Organoaluminum compounds of this invention can be prepared by any suitable method, including currently known methods, as will be familiar to those skilled in the art, or methods that may come to be known.

### Lewis Bases

Lewis base can comprise primary amine NH₂R², secondary amine NHR²₂, or tertiary amine NR²₃ or any mixture thereof, wherein R² in each occurrence is hydrogen or hydrocarbyl group having up to about 20 carbon atoms, and each R² may be the same as, or different from, any other R². For example, Lewis base can comprise a variety of amines, including, but not limited to, NMe₂Ph, NMe₂(CH₂Ph), NEt₂Ph, NEt₂(CH₂Ph), or Lewis base can comprise one or more long chain amines such as NMe(CₚH₂ₙ₊₁)(CₘH₂ₘ₊₁), NMe₂(CₚH₂ₚ₊₁), NEt(CₚH₂ₚ₊₁)(CₘH₂ₘ₊₁), or NEt₂(CₚH₂ₚ₊₁), wherein p and m are selected independently from an integer from about 3 to about 20. Examples of long chain amines of the formula NMe(CₚH₂ₚ₊₁)(CₘK₂ₘ₊₁) include, but are not limited to, compounds such as NMe(C₁₆H₃₃)₂, NMe(C₁₇H₃₅)₂, NMe(C₁₈H₃₇)₂, NMe(C₁₆H₃₃)(C₁₇H₃₅), NMe(C₁₆H₃₃)(C₁₈H₃₇H), NMe(C₁₇H₃₅)(C₁₈H₃₇), and the like. For example, NMe(C₁₆H₃₃)₂ is typically the major species in a commercial long chain amine composition that usually comprises a mixture of several amines. Lewis base may comprise NMe₂Ph, NMe₂(CH₂ Ph), NEt₂Ph, NEt₂(CH₂Ph), NMe(C₁₆H₃₃)₂. Lewis base can also comprise phosphines. Lewis base can comprise N,N-dimethylbenzoamine, trimethylamine, N,N-dimethylanaline triethylamine, and the like.

### Bronsted Acids

Bronsted acid, i.e., a compound capable of donating a proton, useful in this invention can comprise 2,6-difluorophenol, pentafluorophenol, 4-fluorophenol, or any phenol that is able to react with Lewis base to form at least one ionic Bronsted acidic compound.

### Ionic Compound

In this invention, the Lewis base and the Bronsted acid form at least one ionic Bronsted acid. Ionic Bronsted acid can be derived from Lewis base and at least 2 equivalents of Bronsted acid per equivalent of the Lewis base. The ionic Bronsted acid can have a characteristic N—H stretching frequency in the N—H stretching frequency area at about 3250 cm⁻¹, e.g., at about 3253 cm⁻¹, as can be identified with IR spectroscopy.

Ionic compound having at least one active proton, which is derived from N,N-dimethylaniline and pentafluorophenol, can be derived from N,N-dimethylaniline and at least 2 equivalents of pentafluorophenol per equivalent of the N,N-dimethylaniline.

Preparation of Compositions of this Invention

Activator compositions according to this invention are derived from at least carrier containing water, organoaluminum compound, Lewis base, and Bronsted acid. The carrier can be combined with the organoaluminum compound to form first product, at least a portion of the first product can be combined with the Bronsted acid to form second product, and at least a portion of the second product can be combined with the Lewis base. The organoaluminum compound can be combined with Lewis base to form first product, at least a portion of the first product can be combined with the carrier to form second product, and at least a portion of the second product can be combined with Lewis base and Bronsted acid in amounts sufficient and under condition sufficient that the Lewis base and the Bronsted acid form at least one ionic Bronsted acid. Activator composition can be derived from carrier containing water, organoaluminum compound, Lewis base, and Bronsted acid combined in any order. The ionic Bronsted acid can be derived from N,N-dimethylaniline and at least 2 equivalents of pentafluorophenol per equivalent of the N,N-dimethylaniline. Activator composition can be derived from carrier containing water, organoaluminum compound, ionic compound having at least one active proton, and Lewis base, combined in any order.

This invention also provides that a portion of pentafluorophenol can be combined with organoaluminum to form a first mixture; then the first mixture can be combined with carrier to form a second mixture; then the second mixture can be combined with Lewis base or ionic Bronsted acid to form a composition according to this invention.

The combining can be conducted in an inert gas atmosphere; at a temperature from about −80° C. to about 200° C., or from about 0° C. to about 120° C.; the combining time can be from about 1 minute to about 36 hours, or from about 10 minutes to about 24 hours. Solvent used for preparing activator composition can comprise aliphatic solvent or aromatic solvent, either of which is inert to the carrier, the organoaluminum compound, the Lewis base, the Bronsted acid, and the ionic Bronsted acid. Example treatments after completion of the combining operation include filtration of supernatant, followed by washing with inert solvent and evaporation of solvent under reduced pressure or in inert gas flow, but these treatments are not required. Resulting activator composition can be used for polymerization in any suitable state, including fluid, dry, or semi-dry powder, and may be used for polymerization in the state of being suspended in inert solvent. The combining of carrier containing water with organoaluminum compound can be conducted at ambient temperature and at a combining time of from about 15 minutes to about 48 hours, or from about 15 minutes to about 6 hours; the resulting combination can be used as is or subsequently heated to a temperature of about 80° C. to about 120° C. Alternatively, the combining of carrier containing water with organoaluminum compound can be conducted at a temperature of from about 80° C. to about 120° C. at a combining time of from about 15 minutes to about 6 hours. At least a portion of resulting product is combined with ionic Bronsted acid, which is separately derived from Lewis base and Bronsted acid, for example, from N,N-dimethylaniline and at least 2 equivalents of pentafluorophenol per equivalent of the N,N-dimethylaniline.

Trialkylaluminum compound can be combined with pentafluorophenol to form a first product: which can then be combined with carrier containing water and N,N-dimethylaniline to form an activator composition, all such that the activator composition comprises at least 2 equivalents of pentafluorophenol per equivalent of the N,N-dimethylaniline.

The amount of aluminum atom in the product, e.g., solid component, obtained by combining low-temperature calcined carrier and trialkylaluminum compound can be not less than about 0.1 mmol aluminum atom, or not less than about 1 mmol aluminum atom, in 1 g of the solid component in the dry state. When solid component obtained by combining low-temperature calcined carrier and trialkylaluminum compound is combined with ionic compound having at least one active proton, the molar ratio of active proton to aluminum atom of trialkylaluminum compound in the solid component can be from about 0.02 to about 1, or from about 0.05 to about 0.5, or from about 0.1 to about 0.3.

### Catalysts for Olefin Polymerization

Activator compositions of this invention are useful in catalysts for olefin polymerization. Activator composition according to this invention and transition metal component may each be added independently, yet substantially simultaneously, to monomer to catalyze polymerization. Activator composition and transition metal component may be combined to form product and at least a portion of product may be added to monomer to catalyze polymerization. The active proton ratio of activator composition to transition metal atom of transition metal component may be 0.1 to 4, or 0.5 to 2, or almost 1.

Activator composition is suitable for activating transition metal component by Bronsted acidity, i.e., by protonating alkylated transition metal component. Activator composition is also suitable for activating transition metal component by Lewis acidity, i.e., by accepting at least one electron pair from transition metal component. The amount of activator composition combined with transition metal component may be sufficient to allow activation of transition metal component predominantly by Bronsted acidity; e.g., 30% or more, 70% or more, or 90% or more of activation may occur due to Bronsted acidity. The amount of activator composition combined with transition metal component may be sufficient to allow activation of transition metal component substantially by Bronsted acidity, e.g., 95% or more, or 98% or more of activation may occur due to Bronsted acidity. Activator composition may be combined with transition metal component either before combining with monomer or while simultaneously combining with monomer. Given a known activator composition and a known transition metal component, one skilled in the art can determine the amount of the activator composition to combine with transition metal component to allow activation predominantly or substantially by Bronsted acidity.

### Catalysts for Olefin Polymerization—Transition Metal Component

Transition metal component can comprise any alkylated transition metal component having olefin polymerization potential. For example, without limitation, transition metal component can comprise one or more metallocene transition metal components.

Transition metal component can comprise alkylated catalyst precursor MLₐR_{q·a} (wherein M represents transition metal atom of the 4th Group or Lanthanide Series of the Periodic Table of Elements (1993, IUPAC), and examples thereof include transition metals of the 4th Group of the Periodic Table, such as titanium atom, zirconium atom and hafnium atom and transition metals of the Lanthanide Series, such as samarium; L represents group having cyclopentadienyl skeleton or group having at least one hetero atom, at least one L being group having cyclopentadienyl skeleton, and a plurality of L may be the same or different and may be crosslinked to each other; R represents hydrocarbon group having 1 to about 20 carbon atoms; “a” represents a numeral satisfying the expression 0≦a≦q; and q represents valence of transition metal atom M).

In L in transition metal component, group having cyclopentadienyl skeleton can comprise, for example, cyclopentadienyl group, substituted cyclopentadienyl group or polycyclic group having cyclopentadienyl skeleton, Example substituted cyclopentadienyl groups include hydrocarbon group having 1 to about 20 carbon atoms, halogenated hydrocarbon group having 1 to about 20 carbon atoms, silyl group having 1 to about 20 carbon atoms and the like. Silyl group according to this invention can include SiMe₃ and the like. Examples of polycyclic group having cyclopentadienyl skeleton include indenyl group, fluorenyl group and the like. Examples of hetero atom of the group having at least one hetero atom include nitrogen atom, oxygen atom, phosphorous atom, sulfur atom and the like.

Example substituted cyclopentadienyl groups include methylcyclopentadienyl group, ethylcyclopentadienyl group, n-propylcyclopentadienyl group, n-butylcyclopentadienyl group, isopropylcyclopentadienyl group, isobutylcyclopentadienyl group, sec-butylcyclopentadienyl group, tertbutylcyclopentadienyl group, 1,2-dimethylcyclopentadienyl group, 1,3-dimethylcyclopentadienyl group, 1,2,3-trimethylcyclopentadienyl group, 1,2,4-trimethylcyclopentadienyl group, tetramethylcyclopentadienyl group, pentamethylcyclopentadienyl group and the like.

Example polycyclic groups having cyclopentadienyl group include indenyl group, 4,5,6,7-tetrahydroindenyl group, fluorenyl group and the like.

Example groups having at least one hetero atom include methylamino group, tert-butylamino group, benzylamino group, methoxy group, tert-butoxy group, phenoxy group, pyrrolyl group, thiomethoxy group and the like.

One or more groups having cyclopentadienyl skeleton, or one or more group having cyclopentadienyl skeleton and one or more group having at least one hetero atom, may be crosslinked with (i) alkylene group such as ethylene, propylene and the like; (ii) substituted alkylene group such as isopropylidene, diphenylmethylene and the like; or (iii) silylene group or substituted silylene group such as dimethylsilylene group, diphenylsilylene group, methylsilylsilylene group and the like.

R in transition metal component comprises hydrogen or hydrocarbon group having 1 to about 20 carbon atoms. Examples of R include alkyl group having 1 to about 20 carbon atoms such as methyl group, ethyl group, n-propyl group, isopropyl group, n-butyl group, benzyl group and the like.

Examples of transition metal component MLₐR_{q·a}, wherein M comprises zirconium, include bis(cyclopentadienyl)zirconiumdimethyl, bis(methylcylopentadienyl)zirconiumdimethyl, bis(pentamethylcyclopentadienyl)zirconiumdimethyl, bis(indenyl)zirconiumdimethyl, bis(4,5,6,7-tetrahydroindenyl)zirconiumdimethyl, bis(fluorenyl)zirconiumdimethyl, ethylenebis(indenyl)zirconiumdimethyl, dimethylsilylene(cyclopentadienylfluorenyl)zirconiumdimethyl, diphenylsilylenebis(indenyl)zirconiumdimethyl, cyclopentadienyldimethylaminozirconiumdimethyl, cyclopentadienylphenoxyzirconium dimethyl, dimethyl(tert-butylamino)(tetramethylcyclopentadienyl) silanezirconiumdimethyl, isopropylidene(cyclopentadienyl)(3-tert-butyl-5-methyl-2-phenoxy)zirconiumdimethyl, dimethylsilylene(tetramethylcyclopentadienyl)(3-tert-butyl-5-methyl-2-phenoxy) zirconiumdimethyl and the like.

Additional exemplary transition metal components MLₐ R_{q·a} include components wherein zirconium is replaced with titanium or hafnium in the above zirconium components.

Other alkylated catalyst precursors useful in this invention are: rac-dimethylsilylbis(2-methyl-1-phenyl-indenyl)zirconium dimethyl (M1); rac-dimethylsilylbis-(2-methyl-1-indenyl)zirconium dimethyl (M2); rac-dimethylsilylbis(2-methyl-4,5-benzoindenyl)zirconium dimethyl (M3); rac-ethylenebis(tetrahydroindenyl)zirconium dimethyl (M4), and rac-ethylenebis(indenyl) zirconium dimethyl (M5). Alkylated catalyst precursor can be generated in-situ through reaction of alkylation agent with the halogenated version of the catalyst precursor. For example, bis(cyclopentadienyl)zirconium dichloride can be treated with triisobutylaluminum (TIBA) and then combined with activator composition.

Polymerization Using Activator Compositions of this Invention

When using activator compositions of the present invention polymerization, any olefin or diolefin having 2 to 20 carbon atoms can be used as a monomer for polymerization. Specific examples thereof include ethylene, propylene, butene-1, pentene-1, hexene-1, heptene-1, octene-11, nonene-1, decene-1, hexadecene-1, eicocene-1,4-methylpentene-1, 5-methyl-2-pentene-1, vinylcyclohexane, styrene, dicyclopentadiene, norbornene, 5-ethylidene-2-norbornene and the like, but are not limited thereto. In the present invention, copolymerization can be conducted using two or more monomers, simultaneously. Specific examples of the monomers constituting the copolymer include ethylene/an α olefin such as ethylene/propylene, ethylene/butene-1, ethylene/hexene-1, ethylene/propylene/butene-1, ethylene/propylene/5-ethylidene-2-norbornene and the like, propylene/butene-1, and the like, but are not limited thereto.

The polymerization method is not limited, and both liquid phase polymerization method and gas phase polymerization method can be used. Examples of solvent used for liquid phase polymerization include aliphatic hydrocarbons such as butane, pentane, heptane, octane and the like; aromatic hydrocarbons such as benzene, toluene and the like; and hydrocarbon halides such as methylene chloride and the like. It is also possible to use at least a portion of the olefin to be polymerized as a solvent. The polymerization can be conducted in a batch-wise, semibatch-wise or continuous manner, and polymerization may be conducted in two or more stages which differ in reaction conditions. The polymerization temperature can be from about −50° C. to about 200° C., or from 0° C. to about 100° C. The polymerization pressure can be from atmospheric pressure to about 100 kg/cm², or from atmospheric pressure to about 50 kg/cm². Appropriate polymerization time can be determined by means known to those skilled in the art according to the desired olefin polymer and reaction apparatus, and is typically within the range from about 1 minute to about 20 hours. In the present invention, a chain transfer agent such as hydrogen may be added to adjust the molecular weight of olefin polymer to be obtained in polymerization.

Organoaluminum compound can be added during polymerization to remove impurities, such as water. Organoaluminum compound useful herein can comprise a variety of organoaluminum compounds, including at least one currently known organoaluminum compound, for example, organoaluminum compound R³_{c}AlY_{3-c}, (wherein R³ represents a hydrocarbon group having 1 to about 20 carbon atoms; Y represents hydrogen atom and/or halogen atoms; and “c” represents an integer of 0 to 3). Specific examples of R³ include methyl group, ethyl group, n-propyl group, n-butyl group, isobutyl group, n-hexyl group and the like. Specific examples of the halogen atom for Y include fluorine atom, chlorine atom, bromine atom and iodine atom, Specific examples of the organoaluminum compound R³_{c}, AlY_{3-c} include trialkylaluminums such as trimethylaluminum, triethylaluminum, tri-n-propylaluminum, trisobutylaluminum, tri-n-hexylaluminum and the like; dialkylaluminum chloride such as dimethylaluminum chloride, diethylaluminum chloride, di-n-propylaluminum chloride, diisobutylaluminum chloride, di-n-hexylaluminum chloride and the like; alkylaluminum dichlorides such as methylaluminumdichloride, ethylaluminum dichloride, n-propylaluminum dichloride, isobutylaluminum dichloride, n-hexylaluminum dichloride and the like; and dialkylaluminum hydrides such as dimethylaluminum hydride, diethylaluminum hydride, di-n-propylaluminum hydride, diisobutylaluminum hydride, di-n-hexylaluminum hydride and the like.

### EXAMPLES

### Preparation of Ionic Compound

In a drybox, 2.00 g (0.0108 mol) of C₆F₅OH (pentafluorophenol) was mixed with 0.657 g (0.00540 mol) of NMe₂Ph (N,N-dimethylaniline) in a vial. After a few hours the slurry mixture solidified to form a crystalline solid. The resulting solid was analyzed by ¹H NMR and it showed that the solid had a composition of two moles of pentafluorophenol per mole of N,N-dimethylaniline (structure shown below),

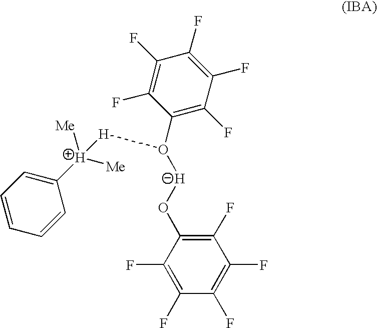

### Conductivity Test of IBA

Table 1 lists the conductivity of several samples.

TABLE 1
Conductivity Results Obtained in CH₃CN
Solution at Room Temperature

| Sample No. | 1 | 2 | 3 | 4 |
|---|---|---|---|---|
| Sample | C₆F₅OH | PhNMe₂ | C₆F₅OH + | C₆F₅OH + |
| | only | only | PhNMe_{2 (1:1)} | 0.5 PhNMe_{2 (2:1)} |
| Concentration | 1.09 | 1.09¹ | 1.09 | 1.09 |
| (mmol/g) of | | | | |
| phenol | | | | |
| Conductivity | 314 | 92.8 | 2.217 | 2.049 |
| (uS/cm) | | | | |

¹concentration of amine (since no phenol included)

The increases in conductivity of samples 3 and 4 (over that of samples 1 and 2) confirms the formation of ionic species. In sample 3, the excess amine adds to the conductivity, but not substantially. The excess amount of amine in the 1:1 charged sample (sample 3) does not form significantly more ionic compound. Therefore, a 1:1 charge of the two components only forms 0.5 equivalent of the ionic species with 0.5 equivalent of excess amine.

### Preparation of AlRₙ(XR¹)₍₃₋ₙ₎ silica

### Example 1

Triethylaluminum (11.44 g, 0.100 mmol Al) and triisobutylaluminum (4.99 g, 0.0251 mmol Al) were dissolved in 400 ml isohexane. Uncalcined silica Grace 952 (40.04 g) was added at room temperature to the alkylaluminum solution slowly under overhead stirring. The reaction temperature was controlled below 31° C. and the total addition time was 7 hours. The slurry was stirred for 1 h and settled overnight. The slurry was filtered and the solid was washed with isohexane (30 g) three times. The product was vacuum-dried and 48.69 g of solid was obtained. Al content in the solid was 5.89%.

### Example 2

Triethylaluminum (14.43 g, 0.12 mmol) was dissolved in 150 ml toluene. Uncalcined silica Grace 952 (40.75 g) was added at room temperature to the alkylaluminum solution slowly under overhead stirring. The reaction temperature was controlled below 29.5° C. and the total addition time was 2 days. The slurry was stirred for 1 h and settled overnight. The slurry was filtered and the solid was washed with isohexane (40 g) three times. The product was vacuum-dried and 46.5 g of solid was obtained. Al content in the solid was 6.80%.

### Preparation of Catalysts

### Example 3

A small portion of the AlRₙ(XR¹)₍₃₋ₙ₎ (where n=3) slurry of Example 1 (1.02 g, 2.23 mmol Al), after isolation, was slurried in 4 g of toluene, IBA (0.220 g, 20 mol % Al) was dissolved in 2 g of toluene and the solution was added to the AlR₃/silica slurry slowly. The reaction was shaken at 500 rpm for 2 hours and then filtered. The solid was washed with 2 g of isohexane twice and transferred to a vial with M5 (16 mg) in it. Another 4 g of toluene was added and the slurry was shaken overnight. The slurry was filtered and the solid was washed with 1 g of toluene three times and 1 g of isohexane three times. The final product was a yellow solid 1.05 g.

### Example 4

A small portion of the AlRₙ(XR¹)₍₃₋ₙ₎, (where n=3) slurry of Example 2 (2.00 g, 5.04 mmol Al) was slurried in 4 g of toluene. IBA (0.310 g, 12.5 mol % Al) was dissolved in 2 g of toluene and the solution was added to the AlR₃/silica slurry slowly. The reaction was shaken at 500 rpm for 2 hours and then filtered. The solid was washed with 2 g of isohexane twice and only half of the solid was transferred to a vial with M1 (24 mg) in it. Another 4 g of toluene was added and the slurry was shaken overnight. The slurry was filtered and the solid was washed with 1 g of toluene three times and 1 g of isohexane three times. The final product was a red purple solid 1.04 g.

Table 2 lists the results from Examples 3 and 4.

TABLE 2
Results from Examples 3 and 4

| | | | Productivity | Activity |
|---|---|---|---|---|
| Example | Al wt % | Zr wt % | (g/g cat/hr) | (kg/g Zr/hr) |
| 3 (M5) | 5.1 | 0.353 | 6,300 | 1,800 |
| 4 (M1) | 6.0 | 0.255 | 27,500 | 10,800 |

### Comparative Examples

### Example 5

A small portion of the AlRⁿ(XR¹)₍₃₋ₙ₎ (where n=3) slurry of Example 2 (1.00 g, 2.52 mmol Al) was mixed with M5 (16 mg). Another 4 g of toluene was added and the slurry was shaken overnight. The slurry was filtered and the solid was washed with 1 g of toluene three times and 1 g of isohexane three times. The final product was an almost white solid.

### Example 6

A small portion of the AlRₙ(XR¹)₍₃₋ₙ₎ (where n=3) slurry of Example 2 (100 g, 2.52 mmol Al) was mixed with M1 (24 mg). Another 4 g of toluene was added and the slurry was shaken overnight. The slurry was filtered and the solid was washed with 1 g of toluene three times and 1 g of isohexane three times. The final product was an almost-white solid.

### Example 7

A small portion of the AlRₙ(XR¹)_{(3-n) (where n=}3) slurry of Example 2 (2.37 g, 5.97 mmol Al) was slurried in 4 g of toluene. C₆F₅OH (0.290 g, 26.4 mol % Al) was dissolved in 2 g of toluene and the solution was added to the AlR₃/silica slurry slowly. The reaction was shaken at 500 rpm for 2 hours and then filtered. The solid was washed with 2 g of isohexane twice and only half of the solid was transferred to a vial with M1 (20 mg). Another 4 g of toluene was added and the slurry was shaken overnight. The slurry was filtered and the solid was washed with 1 g of toluene three times and 1 g of isohexane three times. The final product was a dark green solid.

Polymerization conditions for Examples 3 and 5 using supported M5 catalyst: A 4 L reactor was dried by heating at 100° C. for 15 minutes under low-pressure nitrogen flow. After cooling to ambient, the reactor was pressurized with isobutane and vented three times to remove nitrogen. Isobutane (1800 ml) was charged into the reactor while adding 40 ml of dried 1 hexene and 2 ml of 10% TIBA scavenger, such as organoaluminum compound as described herein. The reactor agitator was set at 800 rpm. After flushing the charging line with 200 ml of isobutane, the reactor was charged with ethylene up to 320 psi for supported M5 while at the same time bringing the temperature of the reactor up to 80° C. Then, 30-100 mg of solid catalyst was slurried in 2 ml of hexane in the glovebox and then injected into the reactor. The reaction pressure was maintained at 320 psi and the polymerization was carried out for 1 hour at 80° C. The reaction was stopped by venting off the ethylene and isobutane. The polymer was isolated, dried, and weighed. The polymerization productivity and activity of each catalyst were calculated.

Polymerization conditions for Examples 4, 6, and 7 using supported M1 catalyst: A 4 L reactor was dried by heating at 100° C. for 15 minutes minimum under low-pressure nitrogen flow. After cooling to ambient, the reactor was charged with 2200 nm of propylene, then 50 ml of 180 psi H₂. 2 ml of 10% TIBA scavenger, such as organoaluminum compound as described herein, was charged into the reactor and the mixture was stirred for 5 minutes. The reactor agitator was set at 800 rpm. Then, 20-50 mg of supported M1 was slurried in 2 ml of hexane in the glovebox and then injected into the reactor. The reaction was heated to 70° C. and the polymerization was carried out for 1 hour at 70° C. The reaction was stopped by venting off the propylene. The polymer was isolated, dried, and weighed. The polymerization productivity and activity of each catalyst were calculated.

Table 3 lists the results from Examples 5, 6 and 7.

TABLE 4
Results from Examples 5, 6 and 7
The results for Comparative samples:

| | | | Productivity | Activity |
|---|---|---|---|---|
| Example | Al wt % | Zr wt % | (g/g cat/hr) | (kg/g Zr/hr) |
| 5 (M5) | 6.7 | 0.310 | 220 | 77 |
| 6 (M1) | 6.7 | 0.050 | 110 | 220 |
| 7 (M1) | 6.1 | 0.138 | 10,000 | 7,250 |

Examples 5 and 6 were prepared with metallocenes on triethylaluminum (“TEA”) coated silica, With only Lewis acid activation, the catalysts had extremely low productivity, only 110-220 g/g cat/hr. With pentafluorophenol on the TEA coated silica in Example 7, Bronsted acid sites were formed and the metallocene was activated by protonation. As a result, the productivity improved dramatically to 10,000 g/g cat/hr. With IBA on the TEA coated silica in Examples 3-4, the activation was due to Bronsted acid sites, but the productivity of catalysts improve much further to 8,300 for M5 and 27,500 g/g cat/hr for M1, The significant improvement of productivity from pentafluorophenol to IBA illustrates the importance of the presence of both the Bronsted acid pentafluorophenol and Lewis base amine.

It is to be understood that the reactants and components referred to by chemical name or formula anywhere in the specification or claims hereof, whether referred to in the singular or plural, are identified as they exist prior to being combined with or coming into contact with another substance referred to by chemical name or chemical type (e.g., another reactant, a solvent, or etc.). It matters not what chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical reaction or in forming a mixture to be used in conducting a desired reaction. Accordingly, even though the claims hereinafter may refer to substances, components and/or ingredients in the present tense (“comprises”, “is”, etc.), the reference is to the substance, component or ingredient as it existed at the time just before it was first contacted, combined, blended or mixed with one or more other substances, components and/or ingredients in accordance with the present disclosure. Whatever transformations, if any, which occur in situ as a reaction is conducted is what the claim is intended to cover. Thus the fact that a substance, component or ingredient may have lost its original identity through a chemical reaction or transformation during the course of contacting, combining, blending or mixing operations, if conducted in accordance with this disclosure and with the application of common sense and the ordinary skill of a chemist, is thus wholly immaterial for an accurate understanding and appreciation of the true meaning and substance of this disclosure and the claims thereof.

While the present invention has been described in terms of one or more preferred embodiments, it is to be understood that other modifications may be made without departing from the scope of the invention, which is set forth in the claims below.

What is claimed is:

1. A composition derived from at least:
a) carrier containing water;
b) organoaluminum compound; and
c) N,N-dimethylaniline and pentafluorophenol in amounts such that there are at least two equivalents of pentafluorophenol per equivalent of the N,N-dimethylaniline.

2. The composition of claim 1, wherein the carrier comprises an inorganic oxide.

3. The composition of claim 2, wherein the inorganic oxide has a pore volume of not less than about 0.3 ml/g and an average particle diameter of about 10 micrometers to about 500 micrometers.

4. The composition of claim 2 wherein the inorganic oxide comprises silica, alumina, silica-alumina, magnesia, titania, zirconia, or clays.

5. The composition of claim 2 wherein the inorganic oxide comprises silica.

6. The composition of claim 1 wherein the organoaluminum compound comprises trimethylaluminum or triethylaluminum.

7. The composition of claim 1, wherein the composition is suitable for activating an alkylated transition metal component by protonatation.

8. A catalyst composition for olefin polymerization, wherein the catalyst composition is prepared by combining at least a composition according to claim 1 and an alkylated transition metal component.

9. A method of preparing a composition comprising combining at least:
a) carrier containing water;
b) organoaluminum compound; and
c) N,N-dimethylaniline and pentafluorophenol in amounts such that there are at least two equivalents of pentafluorophenol per equivalent of the N,N-dimethylaniline.

10. The method of claim 9 wherein the carrier, the organoaluminum compound, the N,N-dimethylaniline, and the pentafluorophenol are combined in amounts sufficient and under conditions sufficient such that the composition is suitable for activating alkylated transition metal component by protonation.

11. A method of preparing a catalyst for olefin polymerization, comprising combining alkylated transition metal component with composition derived from at least carrier containing water; organoaluminum compound; N,N-dimethylaniline; and at least 2 equivalents of pentafluorophenol per equivalent of the N,N-dimethylaniline.

12. A method of polymerizing monomer comprising carrying out such polymerization in the presence of catalyst according to claim 8.

13. A method of polymerizing monomer comprising combining a composition according to claim 1, an alkylated transition metal component, and monomer.

14. A composition derived from at least:
a) carrier containing water;
b) organoaluminum compound;
c) ionic compound having at least one active proton; and
d) Lewis base.

15. The composition of claim 14 wherein the ionic compound having at least one active proton is derived from N,N-dimethylaniline and at least two (2) equivalents of pentafluorophenol per equivalent of the N,N-dimethylaniline.

16. A composition derived from at least:
a) carrier containing water;
b) organoaluminum compound: and
c) ionic compound having at least one active proton, which is derived from N,N-dimethylaniline and pentafluorophenol.

17. A method of preparing a composition comprising combining at least:
a) carrier containing water;
b) organoaluminum compound; and
c) ionic compound having at least one active proton, which is derived from N,N-dimethylaniline and pentafluorophenol.
